(19) United States
(12) Patent Application Publication
(10) Pub. No.: US 2015/0203292 A1
(43) Pub. Date: Jul. 23, 2015

(54) Pivotal Threshold and Attachment to Refuse Container

(71) Applicant: Charles A. Huff, Mountain View, CA (US)

(72) Inventor: Charles A. Huff, Mountain View, CA (US)

(21) Appl. No.: 14/158,328

(22) Filed: Jan. 17, 2014

(51) Int. Cl. B65F 1/14; B65B 67/12; B65F 1/10

(52) U.S. Cl. CPC B65F 1/14; B65F 1/10; B65B 67/12

(57) ABSTRACT

The invention is a convenient ramp-like pivotal threshold attached to a refuse container that is laid over on one side, over which to sweep debris on a floor or ground surface directly into the open end of the container. This invented threshold can be pivoted to be stored out of the way on the outside wall of a conventionally used refuse container standing in a vertical position. This pivotal threshold can be removably or permanently attached to the reinforced rolled edge of the open end of a rectangular solid refuse container or to an axle that is removably or permanently attached to the curved rolled edge of the open end of a refuse container.

### CROSS REFERENCE TO RELATED CASES

This application claims priority benefits of U.S. Provisional Application No. 61/960,998 filed on Oct. 3, 2013.

### BACKGROUND OF THE INVENTION

Presently, refuse, trash, waste, garbage or debris receptacles usually stand vertical on their closed bottom with an open top side and a possible lid. In order to place debris from the floor into a vertical standing receptacle, one must first locate and retrieve a collecting pan and a broom or rake, sweep the debris into the dust pan, lift the loaded pan and dump the pan up and over the open top edge of the container. It usually requires many repetitive trips of this operation and often during this process some of the debris is accidentally dropped or spilled and must be retrieved again. Of course, this is a laborious and time consuming way of using a refuse container. Using one's hands is often an impossible and unhealthy way to solve the foregoing procedural problems.

A process of directly transferring debris from a floor or ground surface into a refuse container, eliminating the need to go through the before mentioned problems with a dust pan, would be very desirable, particularly when cleaning up volumes of materials like particles on a workshop floor or yard trimmings. Further, a ramp-like incline plane surface which would assist with directly sweeping refuse into a container laid over on one side, on the floor, would be more desirable. Finally, a refuse container with a permanently attached pivotal ramp-like threshold which is instantly available yet conveniently and unobtrusively stored on the container, is most desirable.

### INFORMATION DISCLOSURE STATEMENT

The following list of inventions were found to be of interest:

| Mackesy Pat. # 8,490,240 | Thomas et al #D6684177 |
|---|---|
| 7/2013 | 10/2012 |
| Miller Pat. # 8,152,019 | Polkinghorn et al #7,770,576 |
| 4/2012 | 14/2008 |
| Hudson Pat. # 6,877,182 | Springs, II. Wilson #6,974,167 |
| 4/2012 | 12/2005 |
| McCoy et al. Pat. # 8,291,543 | Snyder, James A. #5,511,807 |
| 10/2012 | 04/1996 |
| Simonson Pat. # 7,131,552 | Hodgdon et al #5,222,536 |
| 11/2006 | 06/1993 |
| Mensch Pat. # 6,915,921 | Bulkens, C. #4,907,710 |
| 7/2005 | 03/1990 |
| Lichtenwainer Pat. # 6,318,588 | |
| 11/2001 | |
| Anderson Pat. # 6,155,522 | |
| 12/2000 | |
| DeMars Pat. # 5,611,450 | |
| 3/1997 | |
| Jensen Pat. # 4,802,258 | |
| 2/1989 | |
| Rico Pat. # 4,550,440 | |
| 10/1985 | |
| Cross Pat. # 4,312,531 | |
| 1/1982 | |

### SUMMARY OF THE INVENTION

What is new in the present invention is a pivotal ramp threshold attached to a mount on a solid refuse container, which is laid over on one side and the threshold can be pivoted to be stored in a hanging position on the exterior wall of the container when it is standing vertically and used conventionally. The present invention comprises a configuration of material which creates a reinforced rectangular flat wedge shaped inclined ramp surface, with a thin loading edge, and a thick edge containing a pivotal configuration and possibly raised sloping side edges to channel refuse into the container, made pivotal by a protuberance or perforation of the ramp's axis extending into and rotatable in a perforation or protuberance of a refuse container or this threshold can also be made pivotal by having a ring like structure or channel that pivots around an axle. Of course, this threshold can be made pivotal by any means common to the art. This pivotal threshold can be removably or permanently attached to the straight rolled-edge rim or wall of the open end of a refuse container, or to an axis or axle that is attached to the curved edge rim or wall of the open end of a refuse container. In the permanently attached version of the present invention, it is assumed that changes will need to be made to the construction of the refuse container, such as reinforcing areas and removing rim edges or adding apertures or protuberances to provide a pivotal axis.

The primary object of the present invention is to provide a convenient pivotal ramp threshold over which to sweep debris on a floor or ground surface into the open end of a solid refuse container that is laid over on one side on the surface.

Another object of this invention is to provide a pivotal threshold attached to a refuse container that can pivot out of interference with depositing refuse into the container standing at a vertical position,

Another object of this invention is to provide a refuse container with a pivotal threshold that can be conveniently and unobtrusively stored on the outside of the container.

Another object of this invention is to provide a pivotal threshold for a refuse container which when stored on the container, will not interfere with standard operations like placing a lid on the container, rolling the open end of a liner bag over the open end of the container or laying an object over the open top on the container.

Another object of this invention is to provide a refuse container with a trash collecting threshold which is conveniently found and instantly available when needed.

One more object of this invention is to provide a pivotal threshold attached to the straight rolled-over edge rim of a rectangular refuse container.

Still another object of this invention is to provide a pivotal ramp threshold that can be attached to the curved open top rim or wall of a refuse container by means of a separate attachment bracket mechanism which provides an axis.

One more objective of the invention is to provide a refuse container, with a pivotal threshold, that can be stacked. These and other objects or advantages of the present invention will become fully apparent from the following description, when taken in connection with the accompanying drawings.

### BRIEF DESCRIPTION OF THE DRAWINGS

FIG. 1—is a perspective view of the present invention in a stored position as applied to a rectangular refuse container standing vertically.

FIG. 2—is a perspective view of the present invention in a ramp threshold operating position as applied to a rectangular refuse container laid over on one side.

FIG. 3—is a cross section of the rolled-over top reinforced edge of the container in FIG. 1 where the top edge meets and receives the pivotal axle of the ramp threshold.

FIG. 4—is a partial perspective view illustrating where and how the ramp threshold is attached to the rectangular refuse container.

FIG. 5—is a cross section illustrating how the present invention rotates from the ramp threshold position to the stored position.

FIG. 6—(Canceled)

FIG. 7—(Canceled)

FIG. 8—is a top view of the ramp threshold in FIG. 11 and FIG. 12.

FIG. 9—is a view of the bottom of the threshold in FIG. 11 and FIG. 12.

FIG. 10—is a side view of the short side of FIG. 9.

FIG. 11—is a perspective view of the present invention as attached in a stored position to a cylindrical shaped refuse container standing vertically.

FIG. 12—is a perspective view of the present invention in a ramp threshold operating position as applied to a cylindrical refuse container laid over on one side.

FIG. 13—is a partial side view of the present invention's separate attachment bracket mechanism to a vertically standing cylindrical or rectangular refuse container's top rolled edge cross section, with the threshold in the stored position.

FIG. 14—is a partial side view of the present invention's separate attachment bracket mechanism to a cylindrical or rectangular refuse container's top rolled cross section, while the threshold has been rotated to a ramp threshold position and the container is lying on one side.

FIG. 15—is a partial top view of the present invention's separate attachment bracket mechanism attached to a cylindrical container's rolled top rim and wall.

FIG. 16—is an exploded perspective view of the present invention as applied to attaching the pivotal threshold separate attachment bracket mechanism to a curved refuse container's top rim and wall.

### DETAILED DESCRIPTION

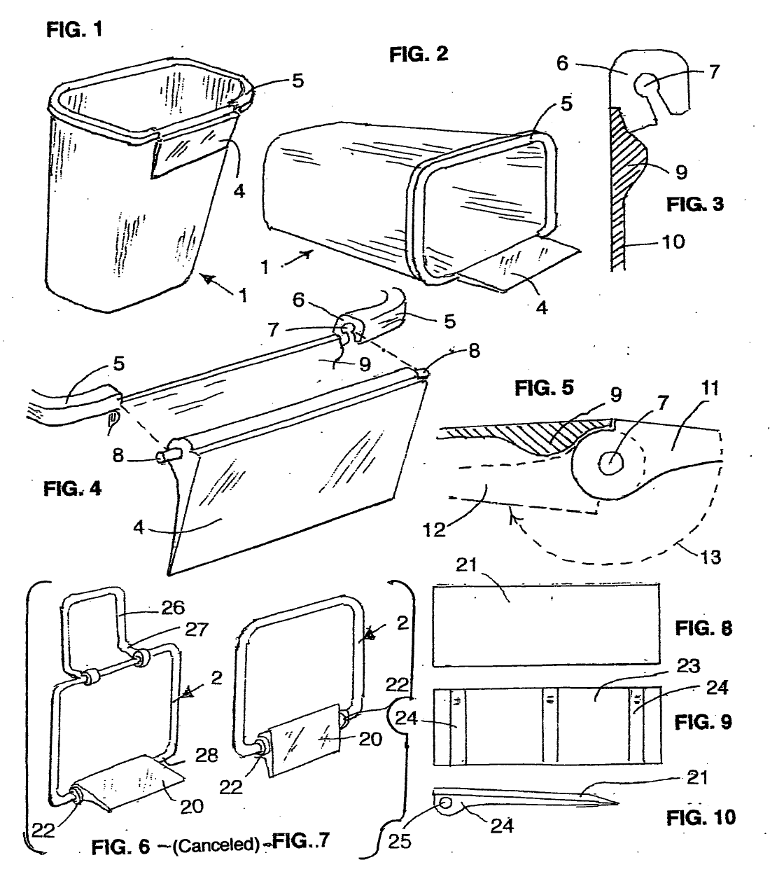

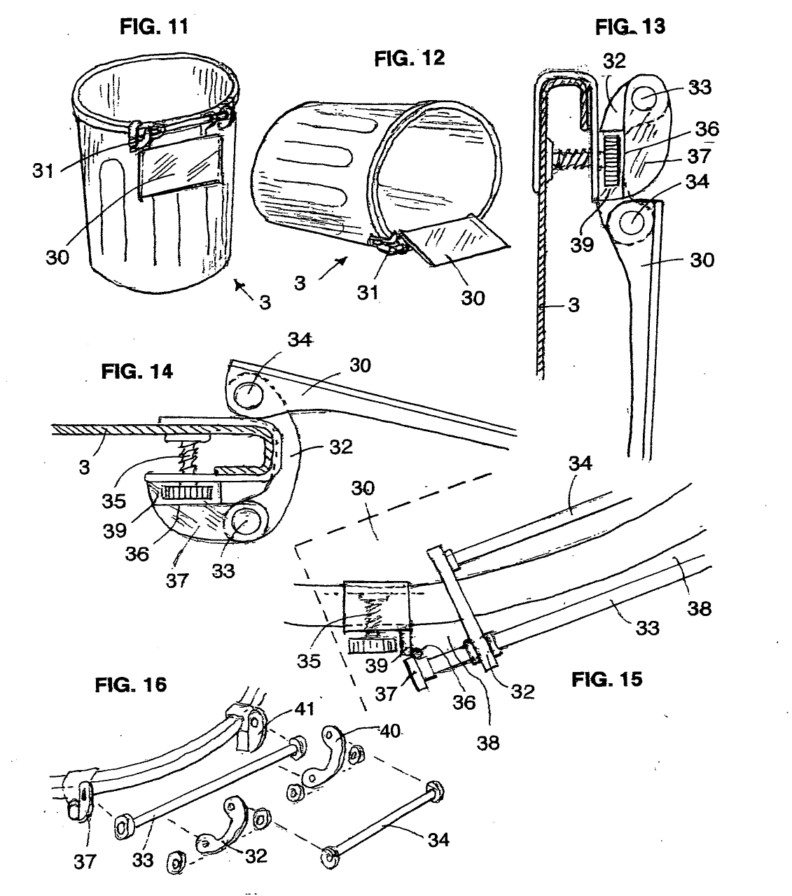

This invention provides a pivotal threshold ramp, with possibly raised sloping side edges, which is attached to a rectangular refuse container or the straight rim edge or wall of a refuse container 1 in FIG. 1, or a cylindrical refuse container 3, see FIG. 11. In the straight edge or rectangular shaped refuse container application, the threshold ramp 4 is pivotal from the stored position in FIG. 1 to the ramp operating position in FIG. 2. Referring to FIG. 4, this pivot action is within the enforced top rolled rim 5 of the container 1. FIG. 3 illustrates a suggested pivotal attachment of the threshold where a solid section 6 is molded or inserted in both open ends of the rolled rim of container 1 and the perforations 7 receives the pivotal protuberances 8 of FIG. 4. Of course, the threshold 4 may be made pivotal by any means in the art. Also, FIG. 3 shows a reinforced section 9 of the container wall 10 where there is an absence of part of the rolled edge, see FIG. 4, of the rectangular container. FIG. 5 illustrates the 180 degree rotation of the invented threshold from the threshold ramp position 11 to the threshold stored position 12 by the path of the arch 13.

In the cylindrical or straight edge refuse container application of the present invention, the pivotal ramp threshold 30 pivots from the stored position in FIG. 11 to the threshold ramp position in FIG. 12, on a separate attachment bracket mechanism 31. The threshold 30 is configured like in FIGS. 8, 9, and 10. FIG. 8, shows the top surface 21 of the ramp threshold 30, as FIG. 9 illustrates the bottom side 23 of the ramp threshold 30 with its struts 24. As shown in FIG. 10, there is a perforated hole or channel 25 on each strut 24 to rotate around axle 34 of the attachment bracket mechanism 31. FIG. 13 shows the axle link 32 of the attachment bracket mechanism 31 in FIG. 11 and the pivotal threshold 30 in the stored position on a vertically standing refuse container wall 3 cross section.

Two linkages of FIG. 16, one of which is 32 as shown in FIGS. 13 and 14, carries one axle 34 whereon the threshold 30 is pivotally mounted while they rotate on the other axle 33 from the vertical storage position in FIG. 13 to the ramp position in FIG. 14 with the refuse container 3 laid on one side. The ramp threshold 30 would be pivotally attached to axle 34. In another alternative figuration, linkages 32 and 40, seen in FIG. 16, could be directly pivotally attached to panels 37 and 41 respectively, eliminating axle 33. Also, the same linkages's 32 and 40 opposite ends, that hold axle 34 , could be directly pivotally attached to the pivotal threshold 30, eliminating axle 34. The ramp threshold 30 could be also directly pivotally attached to panels 37 and 41 eliminating both links 32 and 41 and both axles 33 and 34.

With reference to FIGS. 13, 14 and 15, a screw vise clamp 35 attaches the mechanism to the wall and top rolled rim of a refuse container 3. Of course, this clamp can be a toggle or any means known in the art of attaching the present invention to a refuse container, or the attaching means can be molded as part of the refuse container.

Referring to FIGS. 15 and 16, it will be noticed that there are two hinged 36 panels 37 and 41 that support axle 33, or in the alternative figurations, linkages 32 and 40 or the ramp threshold 30. This is to adapt the clamp 35 to the curve of the cylindrical container's rim and adjust to different rim diameters. The hinged panel 37 as shown in FIGS. 13 and 14, has its hinge in an open flat position suitable for attaching to a straight linear rim or wall of a refuse container, whereas, in FIG. 15 the hinged panel 37 is in a partially closed angled position suitable for a curved rim or wall.

As seen in FIGS. 13, 14 and 15, panel 37 is extended out and then upward from the curved rolled top edge of the refuse container by the hinge's other stationary side 39. The top of this stationary panel 39 is lower than the top of panel 37 and axle 33 in order to provide a space 38, in FIG. 15, to make it possible for a container lid or a liner bag to wrap over and around the curved upper rolled edge of the refuse container when the threshold is in the stored position

FIG. 15 indicates by broken lines, where a corner of the pivotal threshold 30 could be positioned in the ramp position, therefore imagining the position of the total pivotal threshold. In reference to the exploded perspective view in FIG. 16, the pivotal threshold is missing but the attachment bracket mechanism parts are there.

The present embodiment described herein is to be considered in all respects as illustrative and not restrictive. While several embodiments of the invention have been shown and described, it will be apparent that other adaptions and modifications of this invention can be made by those skilled in the art without exceeding the essence and scope of the invention as defined in the following claims.

What is claimed is:

1. A system comprising: an inclined shaped pivotal ramp threshold having a thin end and a thick opposite end, wherein the thick end includes a configuration to pivotally attach to a permanent or removable mount attached to or over a rolled-over edge rim of the open end of a solid base and solid walled refuse container.

2. The system of claim 1 that includes a ramp threshold that pivots on an axis or axle mount that is attached to the solid refuse container.

3. The pivotal ramp threshold according to claim 1 which is attached to or is a part of a straight rolled-over edge rim of the open end of the solid refuse container.

4. The pivotal ramp threshold attachment described in claim 3 which allows for a straight portion of the rolled-over rim of the refuse container to be removed to accommodate the pivotal thick edge of the ramp threshold, and a reinforced wall under the missing edge would be molded or added as well as solid ends on the rolled-over edge with perforations or protuberances to accept the pivotal protuberances or perforations of the ramp threshold.

5. The pivotal ramp threshold described in the system of claim 1 wherein the thick end includes struts with circular perforations or channels in them configured to pivotally attach to an axle attached to the solid refuse container.

6. The pivotal ramp threshold according to claim 1 that is attached and pivots on an axis or axle that is attached to a curved rolled-over edge rim or wall of the open end of the solid refuse container.

7. (canceled)

8. The pivotal ramp threshold according to claim 1 that is attached to or part of a separate attachment bracket mechanism which is attached to or is a part of the solid refuse container.

9. (canceled)

10. The pivotal ramp threshold according to claim 1, or ramp attachment mechanism of claim 8, that is removably attached to the refuse container.

11. The pivotal ramp threshold described in claim 1 that has sloping side edges.

12. The pivotal ramp threshold according to claim 1 that can pivot from an operating ramp position when the refuse container is laid over on one side, to a hanging stored position on an exterior wall of the container when standing vertically.

13. A system as described in claim 1 comprising a separate attachment bracket mechanism that is permanently or removably attached to a rolled-over edge rim of the open end of a solid refuse container and utilizes a stationary axle or axis on which the ramp threshold is pivotally mounted.

14. The pivotal threshold bracket attachment mechanism according to claim 13 that is removably clamped over or permanently molded onto a rolled rim edge or wall of the open end of the refuse container.

15. The attachment bracket mechanism according to claim 14 whereas the clamps are constructed on a hinge or ball joint configuration to be able to adjust to the angle required on the refuse container with a specific curved rim.

16. The separate attachment bracket mechanism according to claim 13 that includes axis holding arms which extend out and then upward, in a U shape, from the refuse container wall to provide space between the container wall and the upward element of each arm to make it possible to wrap a lid or a liner bag over the outside of the container's open end top rolled rim and each holding arm to include a perforation near the top of its upward extension to receive the pivotal means of the ramp threshold.

17-20. (canceled)
